(19) United States
(12) Patent Application Publication
(10) Pub. No.: US 2026/0329096 A1
(43) Pub. Date: Oct. 22, 2026

(54) WEARABLE ELECTRONIC DEVICE

(71) Applicant: Apple Inc., Cupertino, CA (US)

(72) Inventors: Daniel S. Davidson, Mill Creek, WA (US); Alexander B. von Schulmann, Sunnyvale, CA (US); Matin Seadat Beheshti, Sunnyvale, CA (US); Teodor Dabov, San Francisco, CA (US); Trevor S. Chambers, San Diego, CA (US)

(21) Appl. No.: 19/327,739

(22) Filed: Sep. 12, 2025

Related U.S. Application Data
(60) Provisional application No. 63/792,510, filed on Apr. 22, 2025.

(51) Int. Cl. G02B 27/01; G02C 5/04

(52) U.S. Cl. CPC G02B 27/0176; G02C 5/045; G02C 2200/06

(57) ABSTRACT

A wearable electronic device can include a frame, a first optical module including a first housing and a first display window coupled to the first housing, a second optical module including a second housing and a second display window coupled to the second housing, a first adjustment system including a first rod coupled to the frame, and a second adjustment system including a second rod coupled to the frame. The first housing can be movably coupled to the first rod and the second housing can be movably coupled to the second rod. The first housing and the second housing can be configured to be independently movably along the first rod and the second rod.

### CROSS-REFERENCE TO RELATED APPLICATIONS

This application claims the benefit of U.S. Provisional Application No. 63/792,510, filed 22 Apr. 2025, entitled “WEARABLE ELECTRONIC DEVICE,” the entire disclosure of which is hereby incorporated by reference.

### FIELD

The present disclosure relates generally to wearable electronic devices. More particularly, the present disclosure relates to an adjustment system for wearable electronic devices.

### BACKGROUND

Various components of wearable electronic devices, such as head-mountable displays (HMD), can include display screens, viewing frames, securement arms, speakers, batteries, waveguides, and other components, which operate together to provide an immersive experience. User's heads vary in size and shape, and more specifically the distance between a user's eyes, otherwise known as interpupillary distance (IPD), can vary from user to user. Display screens or display lenses provide the most optimal immersive experience when the lenses are positioned directly in front of the user's eyes. However, many lenses in HMD's can be difficult to adjust and properly position in front of the user's eyes. Therefore, there is a need for an HMD with an effective and simple-to-use an adjustment system to position the lenses in front of the user's eyes.

### SUMMARY

At least one example of the present disclosure includes a wearable electronic device including a frame, a first optical module including a first housing and a first display window coupled to the first housing, a second optical module including a second housing and a second display window coupled to the second housing, a first adjustment system including a first rod coupled to the frame, and a second adjustment system including a second rod coupled to the frame. The first housing is movably coupled to the first rod and the second housing is movably coupled to the second rod. The first housing and the second housing are configured to be independently movable along the first rod and the second rod.

In one example, the first adjustment system can include a first adjustment device configured to translate the first housing along the first rod and secure the first housing in a first location, and the second adjustment system can include a second adjustment device configured to translate the second housing along the second rod and secure the second housing in a second location. In one example, the first adjustment system can include a first spring and a first ball bearing coupled to the first spring, the first rod can include a first detent configured to engage the first ball bearing, the second adjustment system can include a second spring and a second ball bearing coupled to the second spring, and the second rod can include a second detent configured to engage the second ball bearing. In one example, when the first optical module and the second optical module are in a first position, the first rod can be configured to secure the first optical module in the first position and the second rod can be configured to secure the second optical module in the first position, when the first optical module is in a second position, the first rod can be configured to secure the first optical module in the second position, and when the second optical module is in a third position, the second rod can be configured to secure the second optical module in the third position. In one example, the wearable electronic device can include a projector configured to display light at the first transparent window and the second transparent window. In one example, the first adjustment system can include a first motor configured to move the first housing along the first rod, and the second adjustment system can include a second motor configured to move the second housing along the second rod. In one example, the first housing can be movably coupled to the first rod at a first upper portion of the first housing, the first adjustment system can include a third rod coupled to the frame, the first housing can be movably coupled to the third rod at a first lower portion of the first housing, the second rod can be movably coupled to the second housing at a second upper portion of the second housing, the second adjustment system can include a fourth rod coupled to the frame, the second housing can be movably coupled to the fourth rod at a second lower portion of the second housing. In one example, the first adjustment system can include a first locking mechanism configured to secure the first housing at a first location on the first rod, and the second adjustment system can include a second locking mechanism configured to secure the second housing at a second location on the second rod. In one example, the first rod can be configured to secure the first optical module at one of a first set of positions, and the second rod can be configured to secure the second optical module at one of a second set of positions.

In at least one example of the present disclosure, a wearable electronic device includes a frame including an intermediate frame, a first rod extending from a first side of the intermediate frame, and a second rod extending from a second side of the intermediate frame, a first optical module movably coupled to the first rod, the first optical module including a first transparent window, a second optical module movably coupled to the second rod, the second optical module including a second transparent window, a first adjustment system configured to move the first optical module along the first rod, a second adjustment system configured to move the second optical module along the second rod, and a third adjustment system configured to couple the first adjustment system to the second adjustment system.

In one example, the third adjustment system can be configured to synchronize a combined movement including the first adjustment system moving the first optical module and the second adjustment system moving the second optical module. In one example, the third adjustment system can be configured to symmetrically move the first optical module with the first adjustment system and the second optical module with the second adjustment system. In one example, the first adjustment system can include a first spring, and a first ball bearing coupled to the first spring and the second adjustment system can include a second spring and a second ball bearing coupled to the second spring. In one example, the third adjustment system can be positioned between the first optical module and the second optical module. In one example, the first adjustment system can be positioned above the first transparent window of the first optical module and the second adjustment system can be positioned above the second transparent window of the second optical module. In one example, the frame can include a third rod extending from the first side of the intermediate frame, the first optical module can be movably coupled to the third rod, a fourth rod extending from the second side of the intermediate frame, and the second optical module can be movably coupled to the fourth rod.

In at least one example of the present disclosure, a smart glasses device includes a frame, a first optical module positioned at a first side of the frame, the first optical module including a first housing and a first transparent window, a second optical module positioned at a second side of the frame, the second optical module including a second housing and a second transparent window, a first adjustment system, and a second adjustment system. The first adjustment system includes a first rod coupled to the frame at an upper portion of the first side of the frame, a second rod coupled to the frame at a lower portion of the first side of the frame, and first adjustment mechanism. The first optical module is movably coupled to the first rod and the second rod. The first adjustment mechanism is configured to move the first optical module along the first rod and the second rod. The second adjustment system includes a third rod coupled to the frame at the upper portion of the second side of the frame, a fourth rod coupled to the frame at the lower portion of the second side of the frame, and a second adjustment mechanism. The second optical module is movably coupled to the third rod and the fourth rod. The second adjustment mechanism is configured to move the second optical module along the third rod and the fourth rod.

In one example, the first rod can include a first detent and a second detent configured to engage with the first adjustment mechanism, the first detent can be configured to secure the first optical module in a first position and the second detent can be configured to secure the first optical module in a second position, and the second rod can include a third detent and a fourth detent configured to engage with the second adjustment mechanism, the third detent can be configured to secure the second optical module in a third position and the fourth detent can be configured to secure the second optical module in a fourth position. In one example, the first adjustment system and the second adjustment system can be configured to independently move the first optical module and the second optical module. In one example, the smart glasses device can include a third adjustment system configured to couple the first adjustment system to the second adjustment system.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of one example of a wearable electronic device;

FIG. 2 illustrates a perspective view of one example of a wearable electronic device;

FIG. 3 illustrates a perspective view of one example of an adjustment system of a wearable electronic device;

FIG. 4A illustrates a perspective view of one example of a wearable electronic device and an adjustment system;

FIG. 4B illustrates a perspective view of one example of an adjustment system of a wearable electronic device;

FIG. 5 illustrates a perspective view of one example of an adjustment system of a wearable electronic device;

FIG. 6 illustrates a perspective view of one example of an adjustment system of a wearable electronic device; and

FIG. 7 illustrates a perspective view of one example of an adjustment system of a wearable electronic device.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure generally relates to electronic devices. More particularly, the present disclosure relates to wearable electronic devices. In at least one example, a wearable electronic device can include a frame and a securement arm extending from the frame to hold the frame on a user's head. Examples of head-mountable devices can include optical devices, for example glasses lenses, goggles with lenses, transparent display windows, display screens or virtual/augmented reality devices that can include optical components. In these examples, the wearable electronic devices can be donned on the head of a user such that optically transparent widows, for example lenses and transparent optical displays, can be positioned in front of a user's eyes. User's heads can vary in size and shape, and more specifically the distance between a user's eyes, otherwise known as interpupillary distance (IPD), can vary from user to user. Display screens, display lenses, or see through lenses provide the optimal immersive experience when the lenses are positioned directly in front of the user's eyes. However, the adjustment of the lenses to match a user's IPD can be difficult as small adjustments to the lens of the wearable electronic devices can affect the immersive experience delivered to the user.

Current wearable electronic devices can include an adjustment system that can adjust the position of the lenses for a user. The current wearable electronic devices can adjust the lenses, but the adjustment systems do not allow for the adjustment of transparent windows or see through lenses and are not able to adjust separate lenses or windows independently of one another. The IPD adjustment systems described herein are designed to symmetrically or asymmetrically adjust the windows of the device and to accommodate to any variety of users and users of any capability. The adjustment system can include features providing tactile feedback to the user. The adjustment system can be positioned to allow a user to be able to see through the lens or window regardless of the position or adjustment of the adjustment system and lens. By positioning the lenses for the user's specific eyes and IPD, the wearable electronic device can deliver an enhanced and prolonged experience comfortable to the user.

In at least one example, the wearable electronic device can include a frame with a first window and a second window coupled to the frame, and an adjustment system. The adjustment system can include two adjustment devices or mechanism. The adjustment devices or mechanisms can be configured to cause movement of the windows by a user pushing or pulling on the lenses. Such adjustment can be done with the wearable electronic device on or off the head of a user. For example, the adjustment system can include an adjustment device or mechanism coupled to each window. The adjustment devices or mechanisms can be configured to independently adjust the windows, providing for asymmetrical adjustment of the windows to accommodate asymmetrical IPDs. In one example, the adjustment devices or mechanisms can be coupled or linked together to provide symmetrical and/or synchronous adjustment of the windows. In one example, a device can be connected to the wearable electronic device to assist with window position. For example, the device can be configured to cause the windows to adjust. In one example, the device can assist with and confirm window position for IPD.

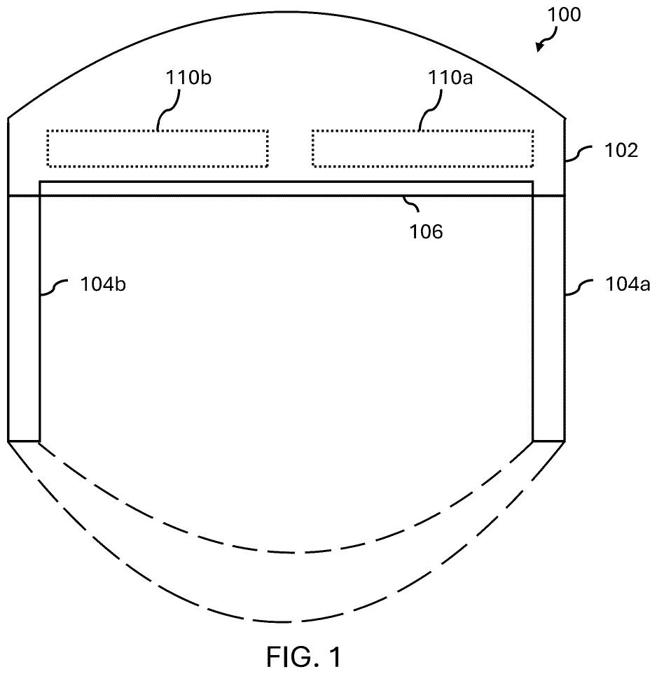

These and other embodiments are discussed below with reference to FIG. 1-7. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of one example of a wearable electronic device 100. The wearable electronic device 100 can be a head-mountable device (HMD) or can be any device or system configured to be worn on the head of a user, such as an optical device, smart glasses, alternate/virtual reality goggles, and the like. As shown in FIG. 1, the device 100 can include at least one frame 102 which can house a variety of components and systems.

The wearable electronic device 100 can include one or more securement arms 104a and 104b. The securement arms 104a-b can be coupled to the frame 102. In one example, the securement arms 104a-b can extend from the frame 102. The securement arms 104a-b can be configured to support the wearable electronic device 100 on the head of a user. In one example, the securement arms 104a-b can be configured to support the wearable electronic device 100 on the ears of the user. The securement arms 104a-b can be configured to extend around the head of the user to support the wearable electronic device 100.

The wearable electronic device 100 can include a facial interface 106. In one example, the frame 102 includes the facial interface 106. For example, the facial interface 106 can be integrated into the frame 102. In one example, the facial interface 106 can be removably coupled to the frame 102. The facial interface 106 can be configured as a light seal configured to block or reduce light that reaches the eyes of a user through the peripheral of the frame 102.

In at least one example, the frame 102 can be configured to secure a display window, display screen, and/or lenses configured to present visual information. In one example of the present disclosure, the wearable electronic device 100 can include a first optical module 110a coupled to the frame 102 and a second optical module 110b coupled to the frame 102. The optical modules 110a-b can include transparent or see-through windows.

The wearable electronic device 100 can include one or more adjustment systems for the optical modules 110a-b. In one example, the adjustment system can be configured independently adjust the optical modules 110a-b. In one example, the adjustment system can be configured to asymmetrically adjust the optical modules 110a-b. In one example, the adjustment system can be configured to simultaneously adjust the optical modules 110a-b. In one example, the adjustment system can be configured to symmetrically adjust the optical modules 110a-b. The adjustment system can be configured to maintain the transparent or see-through windows of the optical modules 110a-b. In one example, the adjustment system can be configured to adjust the optical modules 110a-b with the facial interface in place. In one example, the adjustment system can be configured to adjust the optical modules 110a-b with the facial interface 106 removed.

Any of the features, components, and/or parts, of the wearable electronic device 100 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

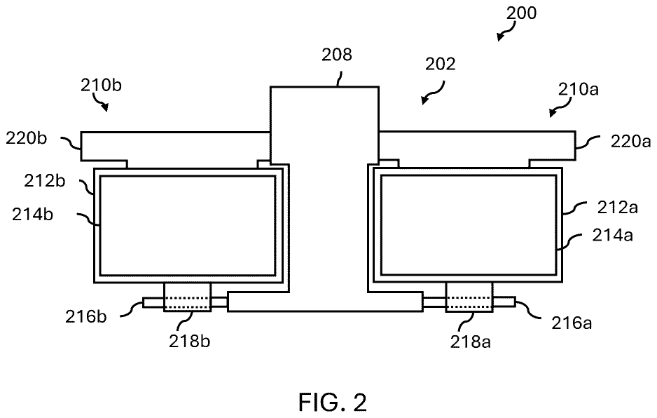

FIG. 2 illustrates a perspective view of one example of a wearable electronic device 200 with an adjustment system 220. In one example, the wearable electronic device 200 can include a frame 202, optical modules 210a-b, and adjustment systems 220a-b. The frame 202 can include a centrally mounted frame 208.

The centrally mounted frame 208 can located near a central axis of the wearable electronic device 200. In one example, the centrally mounted frame 208 can be integrated into the frame 202. In one example, the centrally mounted frame 208 can be located in an internal cavity of the frame 202. The centrally mounted frame 208 can be positioned between the optical module 210a-b. In one example, the centrally mounted frame 208 can house components, such as electric components, adjustment components, or a combination thereof. Positioning components in the centrally mounted frame 208 prevents the components from interfering with the optical modules 210a-b. The centrally mounted frame 208 can be an intermediate frame, positioned within the frame 202.

The wearable electronic device 200 can include lower rods 216a-b. The lower rods 216a-b can extend laterally from the centrally mounted frame 208 toward the first side and the second side. In one example, the lower rods 216a-b can be integrated into the centrally mounted frame 208. In one example, the lower rods 216a-b are coupled to the centrally mounted frame 208. The lower rods 216a-b can be positioned below the optical modules 210a-b. The lower rods 216a-b can be configured to engage with the adjustment systems 220a-b.

The first optical module 210a can be positioned on a first side of the centrally mounted frame. The second optical module 210b can be positioned on a second side of the centrally mounted frame. In one example, the optical modules 210a-b can include optical housings 212a-b and windows 214a-b. The optical housings 212a-b can support the windows 214a-b. As illustrated in FIG. 2, the optical housing 212a-b can surround, or substantially surround, a perimeter of the windows 214a-b. In one example, the optical housings 212a-b can include rod couplers 218a-b. As illustrated in FIG. 2, the rod couplers 218a-b can be positioned, or extend from, a lower portion of the optical housings 212a-b. The rod couplers 218a-b can be configured to engage with the lower rods 216a-b. The rod couplers 218a-b can be movably coupled to the lower rods 216a-b. In one example, the rod coupler 218a-b can be slidably coupled to the lower rods 216a-b.

In one example, the windows 214a-b can include the rod couplers 218a-b, such that the windows 214a-b are configured to move, while the optical housings 212a-b remain stationary. The optical housings 212a-b can be configured to limit movement of the windows 214a-b within a boundary of the optical housings 212a-b.

The windows 214a-b, and other windows shown in other figures and described herein, can include transparent windows without corrective vision properties, such that the windows are see-through windows. The windows described herein can also include corrective vision features. The windows described herein can be configured next to displays to transmit and/or direct light from the displays to the eyes of the user. In one or more examples, the windows 214a-b can include optically transparent display windows, display screens, transparent material, optical lenses, transparent display screens, or combinations thereof, in front of the eyes of the user. In one example, the wearable display device can include a projector configured to display light at windows, such as the transparent windows. While windows 214a-b are used as an example in the present disclosure to describe interpupillary adjustments, the windows 214a-b can be one of a number of components of a display assembly including other components noted above, for example display screens, display support structures, and so forth. Thus, the adjustment in positions of the windows 214a-b shown and described herein can also apply to the adjustment of any other display assembly components, including displays and so forth.

As illustrated in FIG. 2, the adjustment systems 220a-b can be located at or above an upper portion of the optical modules 210a-b. In one example, the adjustment systems 220a-b can be located at or below a lower portion of the optical modules 210a-b. The adjustment systems 220a-b can be configured to modify the interpupillary distance (IPD) between the first window 214a and the second window 214b. For example, the adjustment systems 220a-b can be configured to move the windows 214a-b with respect to one another, the frame, and/or the centrally mounted frame 208. In one example, the adjustment systems 220a-b can be configured to translate the windows 214a-b. For example, the adjustment systems 220a-b can be configured to translate along the lower rods 216a-b. The adjustment systems 220a-b can be configured to independently adjust the windows 214a-b, such that the first adjustment system 220a adjusts the first window 214a and the second adjustment system 220b adjusts the second window 214b. The adjustment systems 220a-b can be configured to asymmetrically adjust the first window 214a and the second window 214b. In one example, the adjustment systems 220a-b can be configured to simultaneously and symmetrically adjust the first window 214a and the second window 214b.

Any of the features, components, and/or parts, of the wearable electronic device 200 including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

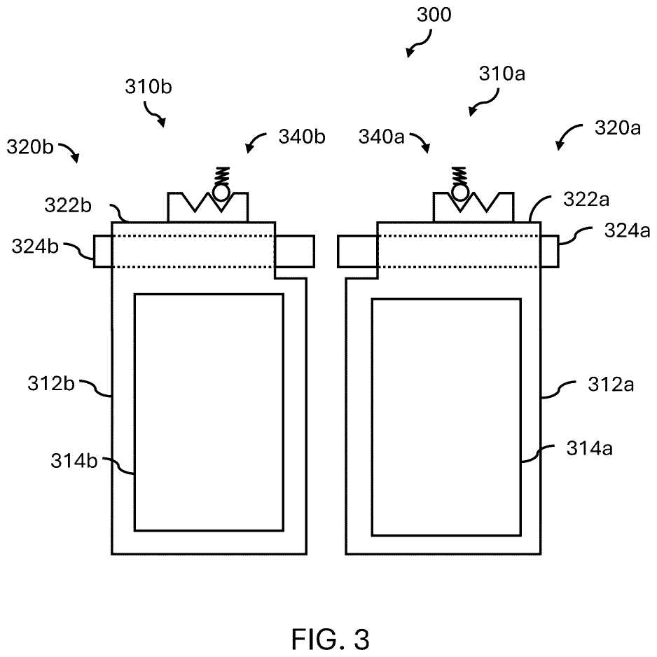

FIG. 3 illustrates a perspective view of one example of an adjustment system of a wearable electronic device 300. The wearable electronic device 300 can include lens modules 310a-b, upper rods 324a-b, a first adjustment system 320a, and a second adjustment system 320b. The optical modules 310a-b can be substantially similar to optical modules 110a-b and 210a-b. The optical modules 310a-b can include optical housings 312a-b and windows 314a-b. The optical housings 312a-b can be substantially similar to the optical housings 212a-b. The windows 314a-b can be substantially similar to the windows 214a-b.

The adjustment systems 320a-b can include upper rods 324a-b, upper rod couplers 322a-b, and compression spring adjustment devices 340a-b. The upper rods 324a-b can extend laterally from a centrally mounted frame of the wearable electronic device 300 toward a first side and a second side. In one example, the upper rods 324a-b can be integrated into the centrally mounted frame. In one example, the upper rods 324a-b are coupled to the centrally mounted frame. The upper rods 324a-b can be positioned above the optical modules 310a-b. The upper rods 324a-b can be configured to engage with the adjustment systems 320a-b.

In one example, the optical housings 312a-b can include the rod couplers 322a-b. As illustrated in FIG. 3, the rod couplers 322a-b can be positioned, or extend from, an upper portion of the optical housings 312a-b. The rod couplers 322a-b can be configured to engage with the upper rods 324a-b. The rod couplers 322a-b can be movably coupled to the upper rods 324a-b. In one example, the rod couplers 322a-b can be slidably coupled to the upper rods 324a-b.

In one example, the windows 314a-b can include the rod couplers 322a-b, such that the windows 314a-b are configured to move, while the optical housings 312a-b remain stationary. The optical housings 312a-b can be configured to limit movement of the windows 314a-b within a boundary of the optical housings 312a-b.

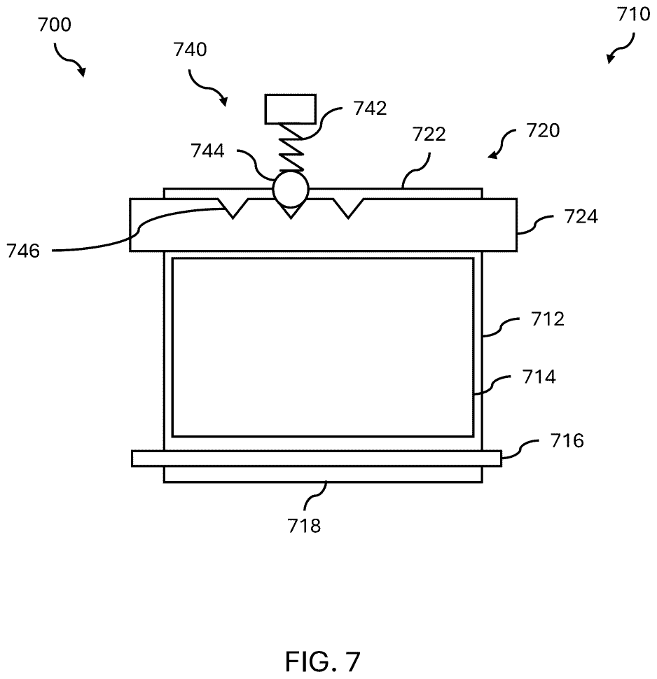

The compression spring adjustment devices 340a-b can be coupled to the rod couplers 322a-b. The compression spring adjustment devices 340a-b can be configured to modify the interpupillary distance (IPD) between the first window 314a and the second window 314b. For example, the adjustment systems 320a-b can be configured to move the windows 314a-b with respect to one another, the frame, and/or a centrally mounted frame. In one example, the adjustment systems 320a-b can be configured to translate the windows 314a-b. For example, the adjustment systems 320a-b can be configured to translate along the upper rods 324a-b. In one example, the compression spring adjustment devices 340a-b can be configured independently adjust the optical modules 310a-b. In one example, the compression spring adjustment devices 340a-b can be configured to asymmetrically adjust the optical modules 310a-b. In one example, the compression spring adjustment devices 340a-b can be configured to simultaneously adjust the optical modules 310a-b. In one example, the compression spring adjustment devices 340a-b can be configured to symmetrically adjust the optical modules 310a-b. As illustrated in FIG. 3, the compression spring adjustment devices 340a-b can be configured to maintain the transparent or see-through windows of the optical modules 310a-b. The compression spring adjustment device 340 is described in more detail with respect to FIG. 7.

The adjustment systems 320a-b can be configured to enable movement of the windows 314a-b without an external actuator. The adjustment systems 320a-b can be configured to enable movement of the windows 314a-b by a user moving the windows 314a-b. The adjustment systems 320a-b can be configured to be manually adjustable or actuatable.

Any of the features, components, and/or parts, of the wearable electronic device 300 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

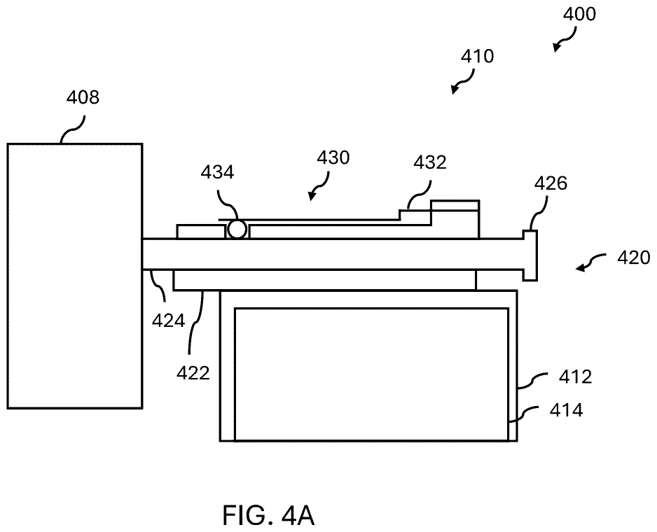

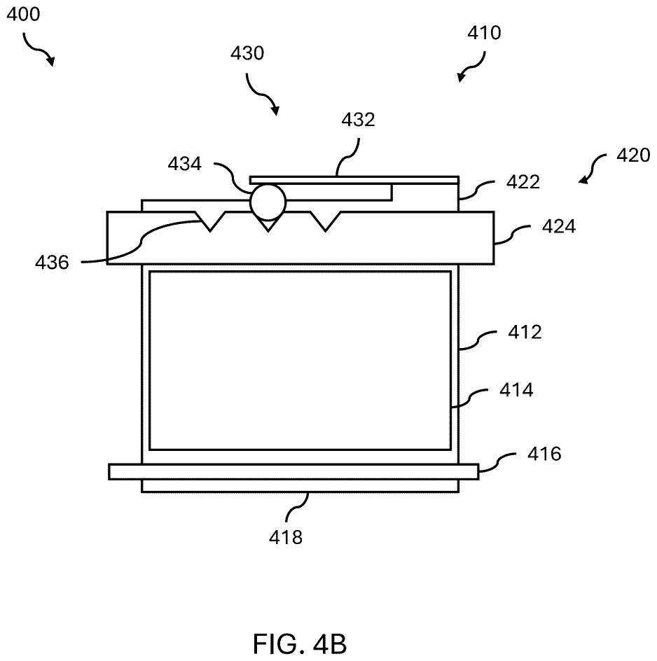

FIGS. 4A and 4B illustrate a perspective view of a portion of one example of a wearable electronic device 400 and an adjustment system 420. The wearable electronic device 400 can include a centrally mounted frame 408, an optical module 410 and a lower rod 416. The centrally mounted frame 408 can be substantially similar to the centrally mounted frame 208. The optical module 410 can be substantially similar to optical modules 110a-b, 210a-b, and 310a-b. The optical module 410a-b can include optical housing 412 and window 414. The optical housing 412 can be substantially similar to the optical housings 212a-b and 312a-b. The optical housing 412 can include a rod coupler 418. The rod coupler 418 can be substantially similar to the rod coupler 218. The window 414 can be substantially similar to the windows 214a-b and 314a-b. The lower rod 416 can be substantially similar to the lower rods 216a-b.

The adjustment system 420 can include an upper rod 424, a rod coupler 422, and an adjustment mechanism 430. The upper rod 424 can extend laterally from the centrally mounted frame 408. In one example, the upper rod 424 can be integrated into the centrally mounted frame 408. In one example, the upper rod 424a-b can be coupled to the centrally mounted frame 408. The upper rod 424 can be positioned above the optical module 410. The upper rod 424 can be configured to engage with the adjustment system 420. As illustrated in FIG. 4A, the upper rod 424 can include an end stop 426.

The end stop 426 can be configured to secure the optical module 410 to the upper rod 424. For example, the end stop 426 can limit movement of the optical module 410 away from the centrally mounted frame 408. In one example, the end stop 426 can be a physical stop. In one example, the end stop 426 can fix a maximum distance of adjustment of the optical module 410.

In one example, the optical housing 412 can include the rod coupler 422. As illustrated in FIGS. 4A-4B, the rod coupler 422 can be positioned, or extend from, an upper portion of the optical housing 412. The rod coupler 422 can be configured to engage with the upper rods 424. The rod coupler 422 can be movably coupled to the upper rod 424. In one example, the rod coupler 422 can be slidably coupled to the upper rod 424. In one example, the window 414 can include the rod coupler 422, such that the window 414 is configured to move, while the optical housing 412 remains stationary. The optical housing 412 can be configured to limit movement of the window 414 within a boundary of the optical housing 412.

The adjustment mechanism 430 can include a leaf spring 432, a ball bearing 434, and one or more detents 436. As illustrated in FIGS. 4A-4B, the leaf spring 432 can be coupled to the rod coupler 422. For example, the leaf spring 432 can be coupled to the optical module 410. The leaf spring 432 can be coupled to the ball bearing 434. The leaf spring 432 can be configured to enable limited movement of the ball bearing 434. In one example, the leaf spring 432 can be configured to provide a downward force on the ball bearing 434 to hold the ball bearing 434 against the upper rod 424, the detents 436, or a combination thereof.

The upper rod 424 can include the one or more detents 436. In one example, the upper rod 424 can include multiple detents 436 in different locations along the upper rod 424. For example, the upper rod 424 can include one to eight detents 436, two to six detents 436, or three detents 436. The detents 436 can be configured to secure a position of the optical module 410. In one example, the detents 436 can be configured to engage the ball bearing 434. For example, the ball bearing 434 can be configured to rest in the detent 436.

The adjustment system 420 can be configured to modify the interpupillary distance (IPD) of the wearable electronic device 400. For example, the adjustment system 420 can be configured to move the window 414. In one example, the adjustment system 420 can be configured to allow translation of the window 414 along the lower rod 416, the upper rod 424, or a combination thereof. The adjustment system 420 can be configured to be manually adjustable or actuatable. For example, the adjustment system 420 can be configured to respond to pulling or pushing of the optical module 410. In one example, pulling or pushing of the optical module 410 can cause the ball bearing 434 to leave a first detent 436 defining a first position of the lens module 410, move along the upper rod 424, and engage in a second detent 436 defining a second position of the optical module 410.

Any of the features, components, and/or parts, of the adjustment system 420 including the arrangements and configurations thereof shown in FIG. 4A-4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4A-4B.

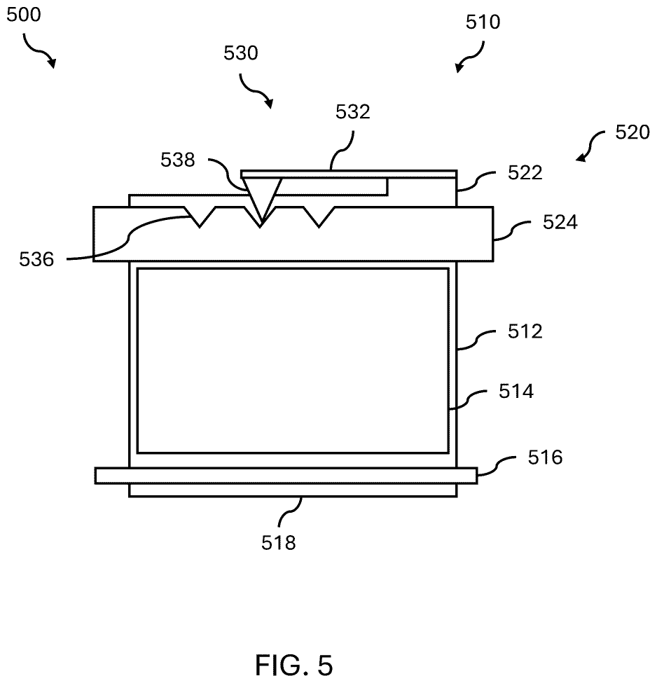

FIG. 5 illustrates a perspective view of one example of an adjustment system 520 of a wearable display device 500. The wearable display device 500 can include an optical module 510, a lower rod 516, and the adjustment system 520. The optical module 510 can be substantially similar to the optical modules 110, 210, 310, and 410. The optical module 510 can include an optical housing 512, a window 514, a lower rod coupler 518, and an upper rod coupler 522. The optical housing 512 can be substantially similar to the optical housings 112, 212, 312, and 412. The window 514 can be substantially similar to the windows 114, 214, 314, and 414. The rod coupler 518 can be substantially similar to the rod couplers 218 and 418. The lower rod 516 can be substantially similar to the lower rods 216 and 416. The rod coupler 522 can be substantially similar to the rod couplers 322 and 422.

The adjustment system 520 can include an adjustment mechanism 530. The adjustment mechanism 530 can include a leaf spring 532, a ramp geometry 538, and one or more detents 536. The leaf spring 532 can be substantially similar to the leaf spring 432. The detents 536 can be substantially similar to the detents 536. The ramp geometry can be coupled to the leaf spring 532. The ramp geometry 538 can have a shape that corresponds to the detents 536. For example, the ramp geometry 538 can have a triangular geometry, a conical geometry, or the like.

The adjustment system 520 can be configured to modify the interpupillary distance (IPD) of the wearable electronic device 500. For example, the adjustment system 520 can be configured to move the optical housing 512 or the window 514. In one example, the adjustment system 520 can be configured to allow translation of the optical housing 512 or the window 514 along the lower rod 516, the upper rod 524, or a combination thereof. The adjustment system 520 can be configured to be manually adjustable or actuatable. For example, the adjustment system 520 can be configured to respond to pulling or pushing of the optical module 510. In one example, pulling or pushing of the optical module 510 can cause the ball bearing 534 to leave a first detent 536 defining a first position of the optical module 510, move along the upper rod 524, and engage in a second detent 536 defining a second position of the optical module 510.

Any of the features, components, and/or parts, of the adjustment system 520 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

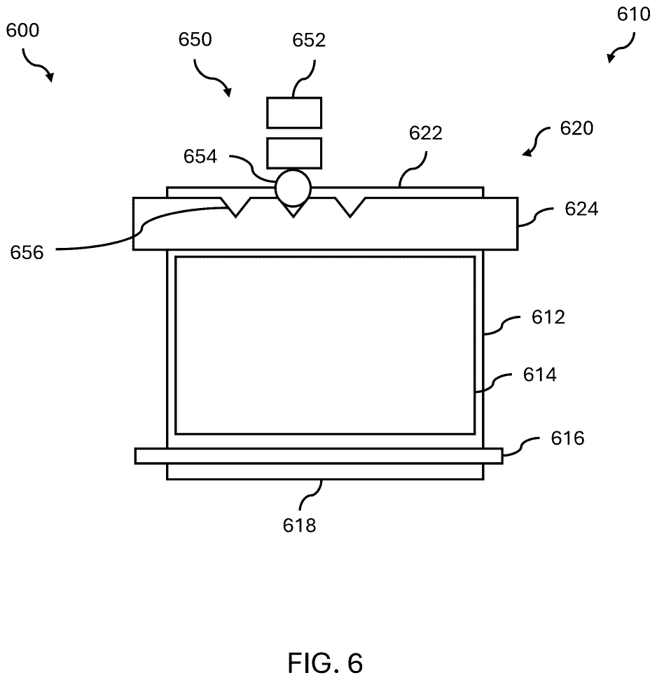

FIG. 6 illustrates a perspective view of one example of an adjustment system 620 of a wearable display device 600. The wearable display device 600 can include an optical module 610, a lower rod 616, and the adjustment system 620. The optical module 610 can be substantially similar to the optical modules 110, 210, 310, 410, and 510. The optical module 610 can include an optical housing 612, a window 614, a rod coupler 618, and a rod coupler 422. The optical housing 612 can be substantially similar to the optical housings 112, 212, 312, 412, and 512. The window 614 can be substantially similar to the windows 114, 214, 314, 414, and 514. The rod coupler 618 can be substantially similar to the rod couplers 218, 418, and 518. The rod coupler 622 can be substantially similar to the rod couplers 322, 422, and 522. The lower rod 616 can be substantially similar to the lower rods 216, 416, and 516.

The adjustment system 620 can include an adjustment mechanism 650. The adjustment mechanism 650 can include a repulse magnet 652, a ball bearing 654, and one or more detents 656. The detents 656 can be substantially similar to the detents 436 and 536.

The repulse magnet 652 can be coupled to the rod coupler 622. For example, the repulse magnet 652 can be coupled to the lens module 610. The repulse magnet 652 can be coupled to the ball bearing 654. The repulse magnet 652 can be configured to enable limited movement of the ball bearing 654. In one example, the repulse magnet 652 can be configured to provide a downward force on the ball bearing 654 to hold the ball bearing 654 against the upper rod 624, the detents 656, or a combination thereof.

The adjustment mechanism 650 can be configured to modify the interpupillary distance (IPD) of the wearable electronic device 600. For example, the adjustment mechanism 650 can be configured to move the optical housing 612 or the window 614. In one example, the adjustment mechanism 650 can be configured to allow translation of the optical housing 612, or the window 614, along the lower rod 616, the upper rod 624, or a combination thereof. The adjustment system 620 can be configured to be manually adjustable or actuatable. For example, the adjustment system 620 can be configured to respond to pulling or pushing of the optical module 610. In one example, pulling or pushing of the optical module 610 can cause the ball bearing 654 to leave a first detent 656 defining a first position of the optical module 610, move along the upper rod 624, and engage in a second detent 656 defining a second position of the optical module 610.

Any of the features, components, and/or parts, of the adjustment system 620 including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

FIG. 7 illustrates a perspective view of one example of an adjustment system 720 of a wearable display device 700. The wearable display device 700 can include an optical module 710, a lower rod 76, and the adjustment system 720. The optical module 710 can be substantially similar to the optical modules 110, 210, 310, 410, 510, and 610. The optical module 710 can include an optical housing 712, a window 714, a rod coupler 718, and a rod coupler 722. The optical housing 712 can be substantially similar to the optical housings 112, 212, 312, 412, 512, and 612. The windows 714 can be substantially similar to the lens 114, 214, 314, 414, 514, and 614. The rod coupler 722 can be substantially similar to the rod couplers 322, 422, 522, and 622. The rod coupler 718 can be substantially similar to the rod couplers 418, 518, and 618. The lower rod 716 can be substantially similar to the lower rods 416, 516, and 616.

The adjustment system 720 can include an adjustment mechanism 740. The adjustment mechanism 740 can include a compression spring 742, a ball bearing 744, and one or more detents 746. The detents 746 can be substantially similar to the detents 436, 536, and 656.

The compression spring 742 can be coupled to the rod coupler 722. For example, the compression spring 742 can be coupled to the optical module 710. The compression spring 742 can be coupled to the ball bearing 744. The compression spring 742 can be configured to enable limited movement of the ball bearing 744. In one example, the compression spring 742 can be configured to provide a downward force on the ball bearing 744 to hold the ball bearing 744 against the upper rod 724, the detents 746, or a combination thereof.

The adjustment system 720 can be configured to modify the interpupillary distance (IPD) of the wearable electronic device 700. For example, the adjustment system 720 can be configured to move the optical housing 712. In one example, the adjustment system 720 can be configured to allow translation of the optical housing 712 along the lower rod 716, the upper rod 724, or a combination thereof. The adjustment system 720 can be configured to be manually adjustable or actuatable. For example, the adjustment system 720 can be configured to respond to pulling or pushing of the optical module 710. In one example, pulling or pushing of the optical module 710 can cause the ball bearing 744 to leave a first detent 746 defining a first position of the optical module 710, move along the upper rod 724, and engage in a second detent 746 defining a second position of the optical module 710.

Any of the features, components, and/or parts, of the adjustment system 720 including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

Referring to FIGS. 1-7 generally, the adjustment systems can include an adjustment mechanism. The adjustment mechanism can include detents, friction clutches, magnetic array clutches, lead screws, rack and pinions, external cams, pin nautilus, belt drives, worm drives, and the like. In one example, the adjustment mechanism can include magnetic detent grooves. In one example, the windows, the optical housing, the optical module, or a combination thereof can include visual or optical feedback indicating a position of the lens, the IPD, or a combination thereof. In one example, the adjustment system can include a lock and unlock button or mechanism. The adjustment system can include coil springs providing a force on an edge region of the rods, to maintain the optical modules on the rod during adjustment. In one example, the adjustment system can include a motor or actuator to automatically adjust the position of the windows, the IPD, or a combination thereof. For example, the adjustment system can include a friction generator that is activated via an SMA, a stepper/brushed motor, or the like. In one example, an SMA can be configured drive the lens modules in a first direction, a second direction, or both.

In one example, the adjustment system can include a linking mechanism of third adjustment mechanism. The linking mechanism can be positioned between the optical modules, the adjustment mechanisms, or a combination thereof. The linking mechanism can be positioned in the centrally mounted frame. The linking mechanism can be configured to link a first adjustment mechanism of a first optical module to a second adjustment mechanism of a second optical module. The linking mechanism can be configured to simultaneously and synchronously adjust the lens modules. In one example, the linking mechanism can be activated and deactivated by a user. The linking mechanism can include a detent, a lead screw, a dial, a timing mechanism, a twist shaft, a roll wheel, a scissor linkage, a binocular type linkage, one or more telescoping rods, a push/pull cable, or the like.

The wearable electronic device can be configured to couple to a device to adjust the IPD of the windows. For example, the wearable electronic device can be configured to connect to another device via a wireless or wired connection. The device can be a portable device, such as a mobile device, tablet, or the like. The device can be used to confirm or assist with IPD adjustment and positioning.

The device can be configured to receive IPD information of the user. In one example, the user can input their IPD, such as from a prescription. In one example, the device can be configured to determine the IPD of a user from a face scan of the user. Using the face scan of the user, the device can determine interpupillary distance (the distance between the pupils of the user; IPD), the interocular distance (the distance between the medial canthus of the user; IOD), measurements of the sphere of the eyeball, contrast, reflection, or the like. Using the IPD and related data, the device can provide a position indication to the user. For example, the device can output the settings for the user to adjust the wearable electronic device optical modules. In one example, the device can be configured to automatically adjust the optical modules to an indicated position. In one example, the device can be configured to confirm whether the user has adjusted the optical modules to the correct position.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable electronic device, comprising:
a frame;
a first optical module comprising a first housing, and a first display window coupled to the first housing;
a second optical module comprising a second housing, and a second display window coupled to the second housing;
a first adjustment system comprising a first rod coupled to the frame, wherein the first housing is movably coupled to the first rod; and
a second adjustment system comprising a second rod coupled to the frame, wherein the second housing is movably coupled to the second rod;
wherein the first housing and the second housing are configured to be independently movable along the first rod and the second rod.

2. The wearable electronic device of claim 1, wherein:
the first adjustment system comprises a first adjustment device configured to translate the first housing along the first rod and secure the first housing in a first location; and
the second adjustment system comprises a second adjustment device configured to translate the second housing along the second rod and secure the second housing in a second location.

3. The wearable electronic device of claim 1, wherein:
the first adjustment system comprises a first spring and a first ball bearing coupled to the first spring;
the first rod comprises a first detent configured to engage the first ball bearing;
the second adjustment system comprises a second spring and a second ball bearing coupled to the second spring; and
the second rod comprises a second detent configured to engage the second ball bearing.

4. The wearable electronic device of claim 1, wherein:
when the first optical module and the second optical module are in a first position, the first rod is configured to secure the first optical module in the first position, and the second rod is configured to secure the second optical module in the first position;
when the first optical module is in a second position, the first rod is configured to secure the first optical module in the second position; and
when the second optical module is in a third position, the second rod is configured to secure the second optical module in the third position.

5. The wearable electronic device of claim 1, further comprising a projector configured to display light at the first transparent window and the second transparent window.

6. The wearable electronic device of claim 1, wherein:
the first adjustment system further comprises a first motor configured to move the first housing along the first rod; and
the second adjustment system further comprises a second motor configured to move the second housing along the second rod.

7. The wearable electronic device of claim 1, wherein:
the first housing is movably coupled to the first rod at a first upper portion of the first housing;
the first adjustment system further comprises a third rod coupled to the frame;
the first housing is movably coupled to the third rod at a first lower portion of the first housing;
the second rod is movably coupled to the second housing at a second upper portion of the second housing;
the second adjustment system further comprises a fourth rod coupled to the frame; and
the second housing is movably coupled to the fourth rod at a second lower portion of the second housing.

8. The wearable electronic device of claim 1, wherein:
the first adjustment system further comprises a first locking mechanism configured to secure the first housing at a first location on the first rod; and
the second adjustment system further comprises a second locking mechanism configured to secure the second housing at a second location on the second rod.

9. The wearable electronic device of claim 1, wherein:
the first rod is configured to secure the first optical module at one of a first set of positions; and
the second rod is configured to secure the second optical module at one of a second set of positions.

10. A wearable electronic device, comprising:
a frame comprising:
an intermediate frame;
a first rod extending from a first side of the intermediate frame; and
a second rod extending from a second side of the intermediate frame;
a first optical module movably coupled to the first rod, the first optical module comprising a first transparent window;
a second optical module movably coupled to the second rod, the second optical module comprising a second transparent window;
a first adjustment system configured to move the first optical module along the first rod;
a second adjustment system configured to move the second optical module along the second rod; and
a third adjustment system configured to couple the first adjustment system to the second adjustment system.

11. The wearable electronic device of claim 10, wherein the third adjustment system is configured to synchronize a combined movement including the first adjustment system moving the first optical module and the second adjustment system moving the second optical module.

12. The wearable electronic device of claim 10, wherein the third adjustment system is configured to symmetrically move the first optical module with the first adjustment system and the second optical module with the second adjustment system.

13. The wearable electronic device of claim 10, wherein:
the first adjustment system comprises a first spring and a first ball bearing coupled to the first spring; and
the second adjustment system comprises a second spring and a second ball bearing coupled to the second spring.

14. The wearable electronic device of claim 10, wherein the third adjustment system is positioned between the first optical module and the second optical module.

15. The wearable electronic device of claim 10, wherein:
the first adjustment system is positioned above the first transparent window of the first optical module; and
the second adjustment system is positioned above the second transparent window of the second optical module.

16. The wearable electronic device of claim 10, wherein the frame further comprises:
a third rod extending from the first side of the intermediate frame, wherein the first optical module is movably coupled to the third rod; and
a fourth rod extending from the second side of the intermediate frame, wherein the second optical module is movably coupled to the fourth rod.

17. A smart glasses device, comprising:
a frame;
a first optical module positioned at a first side of the frame, the first optical module including a first housing and a first transparent window;
a second optical module positioned at a second side of the frame, the second optical module including a second housing and a second transparent window;
a first adjustment system, comprising:
a first rod coupled to the frame at an upper portion of the first side of the frame, wherein the first optical module is movably coupled to the first rod;
a second rod coupled to the frame at a lower portion of the first side of the frame, wherein the first optical module is movably coupled to the second rod; and
a first adjustment mechanism configured to move the first optical module along the first rod and the second rod; and
a second adjustment system, comprising:
a third rod coupled to the frame at the upper portion of the second side of the frame, wherein the second optical module is movably coupled to the third rod;
a fourth rod coupled to the frame at the lower portion of the second side of the frame, wherein the second optical module is movably coupled to the fourth rod; and
a second adjustment mechanism configured to move the second optical module along the third rod and the fourth rod.

18. The smart glasses device of claim 17, wherein:
the first rod comprises a first detent and a second detent configured to engage with the first adjustment mechanism;
the first detent is configured to secure the first optical module in a first position and the second detent is configured to secure the first optical module in a second position; and
the second rod comprises a third detent and a fourth detent configured to engage with the second adjustment mechanism, the third detent is configured to secure the second optical module in a third position and the fourth detent is configured to secure the second optical module in a fourth position.

19. The smart glasses device of claim 17, wherein the first adjustment system is configured to independently move the first optical module relative to the second optical module.

20. The smart glasses device of claim 17, further comprising a third adjustment system configured to couple the first adjustment system to the second adjustment system.
